(19) United States
(12) Patent Application Publication
(10) Pub. No.: US 2011/0090936 A1
(43) Pub. Date: Apr. 21, 2011

(54) SYSTEM AND METHOD FOR USING COHERENTLY LOCKED OPTICAL OSCILLATOR WITH BRILLOUIN FREQUENCY OFFSET FOR FIBER-OPTICS-BASED DISTRIBUTED TEMPERATURE AND STRAIN SENSING APPLICATIONS

(75) Inventor: Vladimir Kupershmidt, San Francisco, CA (US)

(73) Assignee: Redfern Integrated Optics, Inc., Santa Clara, CA (US)

(21) Appl. No.: 12/909,109

(22) Filed: Oct. 21, 2010

Related U.S. Application Data
(60) Provisional application No. 61/253,808, filed on Oct. 21, 2009.

(51) Int. Cl. G01K 11/32; G01L 1/24

(52) U.S. Cl. 374/142; 356/35.5; 374/E11.015

(57) ABSTRACT

Systems and methods are disclosed for distributed temperature and strain sensing along a length of an infrastructure. Two optical sources, such as, external cavity lasers with a narrow linewidth, are used for launching a probe signal into a sensing fiber coupled to the infrastructure, and for producing a local oscillation signal, respectively. The optical sources are coherently locked with a predefined frequency offset with respect to each other, the predefined frequency offset being in the order of the Brillouin frequency shift. The optical sources are included in an optical phase lock loop (OPLL) system. A balanced heterodyne receiver for narrow band detection at radio frequency (RF) bandwidth receives an optical signal generated by coherent mixing of a backscattered probe signal with the Brillouin frequency shift and the local oscillation signal, and produces an output indicative of one or both of a measured temperature and a measured strain.

### CROSS REFERENCE TO RELATED APPLICATION

This application claims priority from U.S. Provisional Application Ser. No. 61/253,808, filed Oct. 21, 2009.

### FIELD OF THE INVENTION

The present invention relates to implementing an integrated fiber-optic sensing system that is configured to use Brillouin frequency shift in a fiber for temperature and strain measurements.

### BACKGROUND

Fiber-optic based sensing is used in various commercial, defense, or scientific applications, such as, fluid flow (e.g., oil or gas flow) characterization, acoustic logging, structural integrity monitoring for terrestrial or under-sea installations, subsurface visualization for geothermal energy exploration, seismic monitoring, etc. Fiber-optic sensors are especially suitable for distributed sensing over a length of a natural or man-made structure which is difficult to access by alternative sensors for local measurement, but at the same time, requires a high-fidelity measurement process for an effective monitoring and control through sensor data analysis. Fiber-optic sensors typically measure change in temperature and/or strain by analyzing the signature of acoustic or optical waves modified at the sensing site that propagate through the sensing optical fiber. Detection and monitoring of temperature and strain allow optimization of process control, avoiding and predicting damage and detecting early signs of abnormal changes in large and/or difficult-to-access structures. Some of the existing high-resolution measurement techniques for distributed fiber optic sensing rely on spontaneous or stimulated Brillouin (SB) or coherent Rayleigh (CR) effects. SB-based sensors use Brillouin Optical Time Domain Analysis/Reflectometry (BOTDA/BOTDR) techniques that are well suited for measurement of distributed fiber static parameters, such as, static temperature and static strain. The Brillouin frequency shift in an optical fiber is typically linearly dependent on fiber strain or temperature.

The BOTDR approach for Brillouin distributed temperature and strain sensing uses laser pulses injected into the sensing fiber and reflected back from spontaneous acoustic waves in the fiber medium. Upon a reflection, the backscattered pulse experiences a frequency shift of ˜11 GHz (for standard single mode fiber, such as SMF-28). The backscattered light is routed to an optical detector where it is mixed with un-shifted optical signal, known as a local oscillator signal generated by an optical or electronic local oscillator (LO). Conventionally, the optical local oscillation frequency is originated from the same laser that sends the sensing laser pulse (i.e. the probe laser), as the LO signal and the sensing pulse need to be coherently locked. Such an approach is called “coherent heterodyne detection”. The objective of the measurements is to determine the central frequency in the gain of the Brillouin spectrum, because the strain and temperature data can be extracted by analyzing the Brillouin spectrum.

Since the BOTDR signal operates with a low intensity backscattered signal, the bandwidth (BW) of the optical detector plays a very critical role in the accuracy of the detection due to the noise in wide BW systems. In the conventional BOTDR method detection, optical beat frequencies require bandwidth in the range of 12 GHz for the optical detector. A high accuracy of frequency detection (in the 1 MHz range) is also required, because a 1 MHz error is equivalent to 1 degree Celsius error in temperature measurements.

Detection with such high bandwidth noisy signal is very difficult and require expensive components. To address such problems, one approach is to use a local oscillation frequency which is shifted from the sensing probe pulse by about 11 GHz, which is the typical range of Brillouin frequency shift. U.S. Pat. No. 7,283,216 describes a system that uses a Brillouin fiber ring laser with 11 GHz shifted carrier as a local oscillator for heterodyne detection in BOTDR method. However, because of the high noise generated in Brillouin fiber ring laser, such method is not very useful in practical implementations with BOTDR detection systems. Also, fiber ring lasers are often more expensive to manufacture and operate than standard semiconductor-based telecom lasers.

Therefore, what is needed is a low-cost high-stability sensing system that can utilize heterodyne detection in a narrow frequency range using standard semiconductor lasers and standard fibers.

### SUMMARY OF THE INVENTION

According to an aspect of the invention, a system is disclosed for distributed temperature and strain sensing along a length of an infrastructure being inspected. The system comprises: a first optical source with a narrow linewidth for launching a probe signal into a sensing fiber coupled to the infrastructure, wherein the probe signal is backscattered from the infrastructure with a Brillouin frequency shift; a second optical source with a narrow linewidth used as a local osclillator producing a local oscillation signal, wherein the first optical source and the second optical source are coherently locked with a predefined frequency offset with respect to each other, the predefined frequency offset being in the order of the Brillouin frequency shift, and wherein the first optical source and the second optical source are included in an optical phase lock loop (OPLL) system; and a balanced heterodyne receiver for narrow band detection at radio frequency (RF) bandwidth that receives an optical signal generated by coherent mixing of the backscattered probe signal with the Brillouin frequency shift and the local oscillation signal, and produces an output indicative of one or both of a measured temperature and a measured strain.

According to another aspect of the invention, a method for distributed temperature and strain sensing along a length of an infrastructure is disclosed, the method comprising: launching a probe signal from a first optical source with a narrow linewidth into a sensing fiber coupled to the infrastructure; routing a backscattered probe signal generated by reflection of the probe signal from the infrastructure with a Brillouin frequency shift to a balanced heterodyne receiver configured for narrow band detection at radio frequency (RF) bandwidth; producing a local oscillation signal from a second optical source with a narrow linewidth used as a local osclillator, wherein the first optical source and the second optical source are coherently locked with a predefined frequency offset with respect to each other, the predefined frequency offset being in the order of the Brillouin frequency shift, and wherein the first optical source and the second optical source are included in an optical phase lock loop (OPLL) system; routing the local oscillation signal to the balanced heterodyne receiver; coherently mixing the backscattered probe signal with the Brillouin frequency shift and the local oscillation signal at the balanced heterodyne receiver; and producing an output indicative of one or both of a measured temperature and a measured strain.

According to yet another aspect, the first optical source and the second optical source are semiconductor-based external cavity lasers (ECLs).

According to yet another aspect, since the second optical source coherently locked with the first optical source with a predefined frequency offset, the system and method allow transfer of heterodyne high frequency RF detection to a narrow frequency band.

According to a further aspect, the predefined frequency offset between the first optical source and the second optical source is optimized using the OPLL system, depending on the type of the sensing fiber used, which dictates the Brillouin frequency shift in the sensing fiber.

According to one other aspect, low cost low-noise radio frequency (RF) electronics is used for the heterodyne receiver to efficiently detect low level amplitude of the backscattered probe signal with the Brillouin frequency shift.

The invention itself, together with further objects and advantages, can be better understood by reference to the following detailed description and the accompanying drawings.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 is a schematic diagram showing the key components of a Brillouin frequency shift-based sensing system, according to an embodiment of the present invention.

FIG. 2 shows details of an example Brillouin frequency shift based sensing system, according to embodiments of the present invention.

FIG. 3 shows a frequency diagram used in the the embodiments of the present invention.

FIG. 4 shows further details of a Brillouin gain spectrum reconstruction scheme, according to an embodiment of the present invention.

### DETAILED DESCRIPTION OF EXAMPLE EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

As described in the Background section, there are growing requirements in infrastructure or geological monitoring for high resolution distributed fiber optic sensing. Distributed sensing is particularly important for detecting early signs of damage along the whole infrastructure, examples of which may be oil pipes that are tens of miles/kilometers long, oil wells, gas distribution lines in cross-country, rural or urban areas etc. Ageing infrastructure has known to cause significant accidents in past and even in recent times. Damages in infrastructure, such as, leaks resulting from corrosion or sudden impact, result in abnormal changes in temperature and strain in certain locations along the infrastructure. Brillouin based systems are capable of providing temperature and strain information distributed along a passive sensing fiber embedded in the infrastructure.

The present invention describes an optical sensing system with an LO signal having a frequency offset of the order of the Brillouin frequency shift, i.e. 8-14 GHz (depending on the type of the sensing fiber), with respect to the probe pulse sent to the sensing fiber. Having such frequency-shifted and coherently locked LO allows to transfer heterodyne high frequency (HF) microwave detection to a narrow frequency band. Detectors have much better sensitivity in the narrow frequency band in the RF region, which is important for detecting low amplitude spontaneous Brillouin-shifted backscattered signal, and offer considerable cost saving operating in such frequency range for BOTDR sensing.

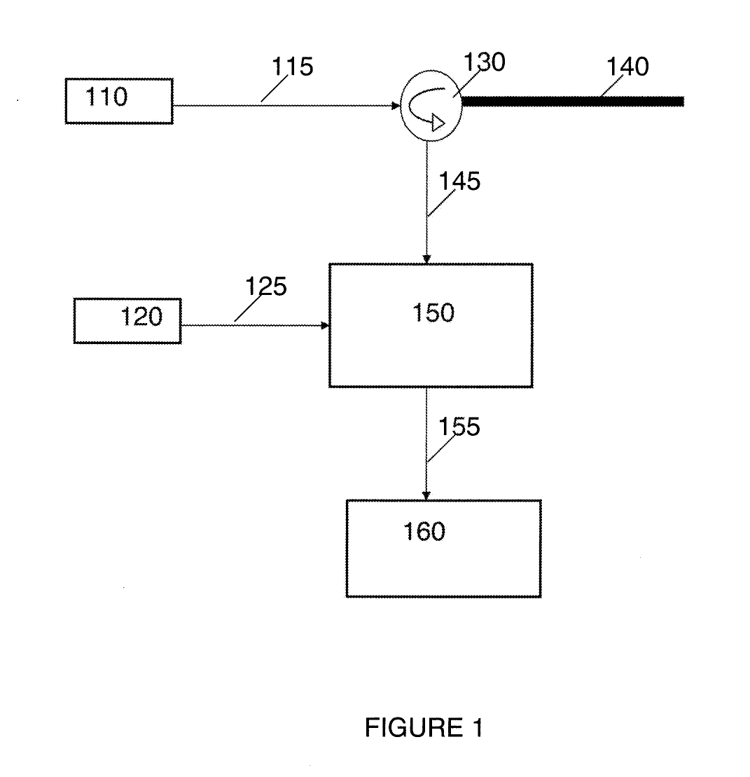

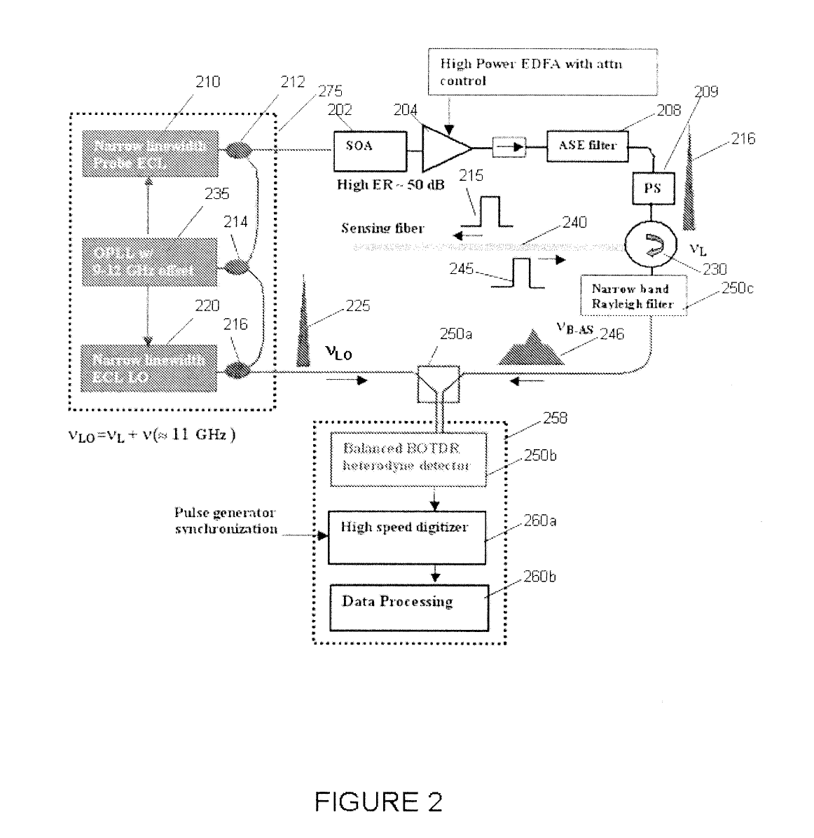

FIG. 1 shows a block diagram showing the key components of a distributed sensing system, according to the present invention. Two narrow linewidth optical sources, 110 and 120 are coherently locked with a fixed frequency offset with respect to each other. 110 is used as a probe laser and 120 is used as a local oscillator. Though not shown specifically in FIG. 1, electronic and optical circuitry (such as an optical phase lock loop, OPLL) are used to maintain the constant frequency offset between the sources 110 and 120. Sources 110 and 120 are external cavity semiconductor lasers (ECLs) in one example embodiment (shown in FIG. 2), though other narrow linewidth lasers may be used. Source 110 is often called a probe laser, and launches a sensing signal or a probe signal 115 (an optical pulse) towards the sensing fiber 140 through an optical coupler 130, which may be a circulator. Backscattered signal 145 is frequency shifted due to spontaneous Brillouin effect. Second source 120 generates local oscillation signal 125, which is at a frequency offset with respect to the probe signal. A heterodyne detection system 150 receives signals 145 and 125, and mixes them up at a mixer to generate a beat frequency in the MHz frequency range. The output 155 of the heterodyne detection system is coupled to a digital signal processor 160, which reconstructs Brillouin spectrum gain, and extracts measured temperature and strain information.

To satisfy the requirements of high resolution temperature (<0.1° C.) and strain (<few με) measurements and fast data acquisition (i.e., fast update rate), it is necessary to have a stable optical source 110, and a stable local oscillator 120. At the same time, the sources need to be coherently locked with a fixed offset in frequency. That can be achieved by an optical phase lock loop (OPLL), which can control and maintain frequency offset between two lasers with an accuracy better than 50 kHz. Co-pending and co-owned patent application Ser. No. 12/788,235, filed May 26, 2010, titled, “A Pair of Optically Locked Semiconductor Narrow Linewidth External Cavity Lasers with Frequency Offset Tuning,” by Kupershmidt, which is incorporated herein by reference in its entirety, describes an OPLL system with frequency offset with offset tuning capability.

FIG. 2 shows an OPLL system 275, which has the phase locking (and optionally, frequency offset tuning) circuitry 235 to maintain the offset between probe laser 210 and LO 220. Though in FIG. 2 it is shown that the frequency offset between ECL 210 and 220 is in the range of 9-12 GHz, the offset actually is determined by the type of fiber used in the system. In general, the frequency offset is in the 8-14 GHz range. The frequency offset can be optimized for the system using the OPLL.

In the example embodiment shown in FIG. 2, the OPLL is based on two narrow linewidth ECLs (probe and LO). In traditional OPLLs, a master laser exhibits superior frequency stability and a narrow linewidth, and the slave laser may be a noisier and less stable, and tries to lock onto the master laser by following the master laser's phase noise characteristics. In the OPLL implementation shown here, instead of using one superior-performance laser, and one inferior performance laser, two substantially identical ECLs may be used with two output optical ports. The two ECLs are selected such that they have a fixed frequency separation (offset) by design or by initial tuning. The frequency offset is maintained.

In one embodiment, the semiconductor ECLs used in the OPLL implementation are based on Planar Lightwave Circuit (PLC) technology with integrated waveguide Bragg grating design. This kind of ECLs exhibit very low frequency noise, low Relative Intensity Noise (RIN) and linewidths less than 10 kHz. PLC-based ECLs may also exhibit polarization selectivity. Other optical components, such as couplers and fibers used in the OPLL system may be chosen to be polarization maintaining (PM) as well.

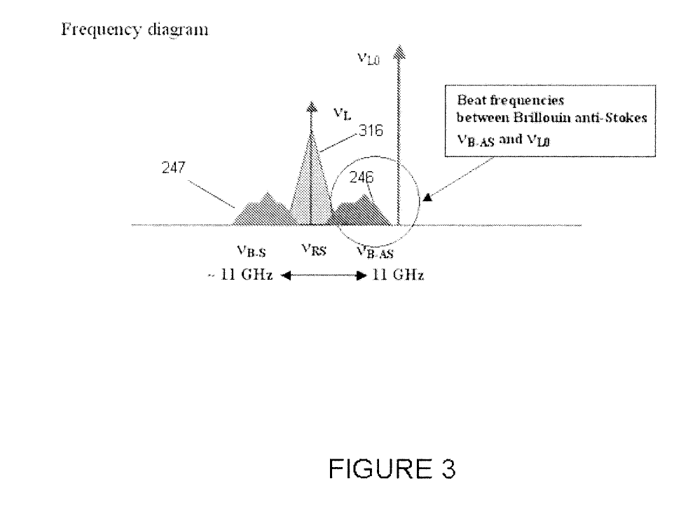

In FIG. 2, splitters 210, 214 and 216 route fractions of the laser outputs for optical phase locking. The remaining significant fractions of the laser outputs are routed towards the respective sensing and measuring components. Output of laser 210 is received by a semiconductor optical amplifier (SOA) 202 that typically has a high extinction ratio (ER, ˜50-55 dB). An Erbium Doped Fiber Amplifier (EDFA) 204 with attenuation control receives the output of the SOA 202. This approach is different from the conventional approach of using an acousto-optic modulator (AOM) r electro-optic modulator (EOM) as pulse generator. In general, AOM generates pulses with high ER in the same range as the ER of SOA, but only for long pulses (˜50-70 nsec) limited by the spatial resolution, while EOM is capable of producing shorter pulses with worse ER (<30 dB). The output of the EDFA 204 then goes to an Amplified Spontaneous Emission (ASE) filter 208, which is used for noise rejection. The output of the ASE filter 208 goes to a pulse shaping (PS) optics 209. Pulse 215 is the narrow linewidth (frequency distribution shown as 216) pulse that is launched into the sensing fiber 240 via the circulator 230. Backscattered pulse 245 has three frequency distributions: a Rayleigh band 316 (shown in FIG. 3), an Brillouin-shifted anti-Stokes band 246 (shown in both FIGS. 2 and 3), and a Brillouin-shifted Stokes band 247 (shown in FIG. 3).

FIG. 3 shows a frequency diagram where the relationship between the respective frequencies are plotted to show how a beat frequency in a narrow frequency range is created for the heterodyne detection. ν_{LO} is the local oscillation frequency of the laser 220, and ν_{L} is the center frequency of the laser 220. ν_{B-AS}, ν_{RS}, and ν_{B-S} are the respective center frequencies in the Brillouin-shifted anti-Stokes band 246, the Rayleigh band 316, and the Brillouin-shifted Stokes band 246. Each of the Brillouin-shifted bands are approximately 11 GHZ away from the center frequency of the probe pulse 215. In the heterodyne detection scheme, the beat frequency is in a narrow spectrum range of a few hundred MHz (typically 200-500 MHz) between ν_{B-AS} and ν_{LO}. Such spectrum range requires considerably lower BW for the optical detector and allows much better signal to noise ratio (S/N) and accuracy of the detection, allowing simplification of the heterodyne detection circuitry and low-noise operation at a low cost

Referring back to FIG. 2, a narrow band Rayleigh filter 250c may be used to filter out the Rayleigh band 316 from the backscattered signal 245, and the anti-Stoke's Brillouin-shifted band 245 is routed to a mixer 250a, which also receives the frequency band 225 in the local oscillation signal coming from source 220. In FIG. 2, the heterodyne detection and data processing system is shown as a combined unit 258, though the functionalities may be distributed between several modules in alternative embodiments. A balanced heterodyne BOTDR detector/receiver 250b sends its output to a high-speed digitizer 260a, coupled to a data processor 260b. Balanced receiver comprises a pair of integrated and power-matched detectors with identical amplifiers, which is known in the art.

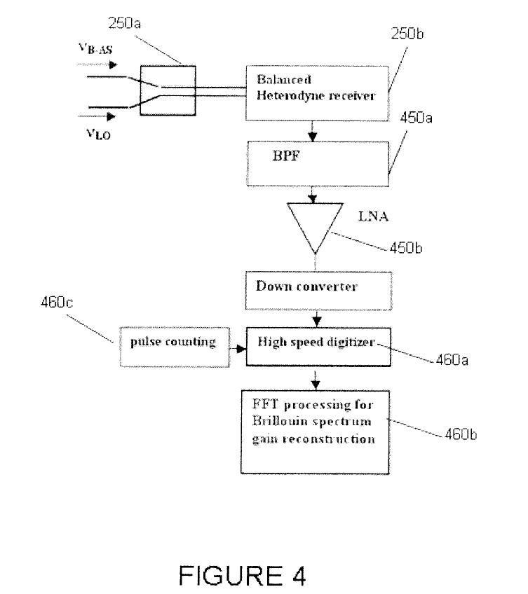

There may be more optional components between the heterodyne detector/receiver 250b and the high-speed digitizer 260a/460a, such as, a band-pass filter (BPF) 450a, a low-noise amplifier (LNA) 450b, and a down-converter 450c, as shown in FIG. 4. A pulse counting circuit 460c is coupled to the high-speed digitizer for pulse synchronization.

The function of the data processor 260b/460b is to reconstruct Brillouin gain spectra. Conventionally, detected beat frequency signal from the heterodyne receiver is mixed with a tunable, electrical local oscillator (ELO), which sweeps the beat frequency range. This operation can be thought of a second heterodyne detection. Selected ELO determines a Brillouin beat frequency and correspondingly, determines the Brillouin gain spectra. The current invention allows an alternative approach for BOTDR processing using Fast Fourier Transform (FFT) to reconstruct Brillouin Spectrum. Finally, by using curve fitting we can find a central frequency of Brillouin gain spectra, which is a linear function of temperature and strain variations.

The descriptions above are intended to be illustrative, not limiting. Thus, it will be apparent to one skilled in the art that modifications may be made to the invention as described without departing from the scope of the claims set out below. Also, the numerical values mentioned in the illustrative examples are not limiting to the scope of the invention.

1. A system for distributed temperature and strain sensing along a length of an infrastructure being inspected, the system comprising:
a first optical source with a narrow linewidth for launching a probe signal into a sensing fiber coupled to the infrastructure, wherein the probe signal is backscattered from the infrastructure with a Brillouin frequency shift;
a second optical source with a narrow linewidth used as a local oscillator producing a local oscillation signal, wherein the first optical source and the second optical source are coherently locked with a predefined frequency offset with respect to each other, the predefined frequency offset being in the order of the Brillouin frequency shift, and wherein the first optical source and the second optical source are included in an optical phase lock loop (OPLL) system; and
a balanced heterodyne receiver for narrow band detection at radio frequency (RF) bandwidth that receives an optical signal generated by coherent mixing of the backscattered probe signal with the Brillouin frequency shift and the local oscillation signal, and produces an output indicative of one or both of a measured temperature and a measured strain.

2. The system of claim 1, wherein the first optical source and the second optical source are semiconductor-based external cavity lasers (ECLs).

3. The system of claim 1, wherein the second optical source coherently locked with the first optical source with a predefined frequency offset allows transfer of heterodyne high frequency RF detection to a narrow frequency band.

4. The system of claim 1, wherein the predefined frequency offset between the first optical source and the second optical source is optimized using the OPLL system, depending on the type of the sensing fiber used, which dictates the Brillouin frequency shift in the sensing fiber.

5. The system of claim 1, wherein low cost low-noise radio frequency (RF) electronics is used for the heterodyne receiver to efficiently detect low level amplitude of the backscattered probe signal with the Brillouin frequency shift, as the required bandwidth of heterodyne detection is reduced as a result of the coherent mixing of the backscattered probe signal with the Brillouin frequency shift and the local oscillation signal, which is already at a predefined frequency offset in the order of the Brillouin frequency shift.

6. The system of claim 1, wherein the balanced heterodyne receiver is coupled to a digitizer, which is coupled to a fast Fourier transform (FFT) processor for reconstructing a Brillouin gain spectrum.

7. The system of claim 6, wherein an electronic local oscillator (ELO) is used to sweep a beat frequency spectrum generated by the balanced heterodyne receiver to reconstruct the Brillouin gain spectrum.

8. The system of claim 1, wherein a beat frequency spectrum produced as a result of the coherent mixing of the backscattered probe signal with the Brillouin frequency shift and the local oscillation signal is in the range of a few hundred MHz.

9. The system of claim 1, where the first optical source is coupled to a semiconductor optical amplifier (SOA) that produces a high extinction-ratio pulse that is amplified by an Erbium-doped fiber amplifier (EDFA) to be used as the probe signal.

10. A method for distributed temperature and strain sensing along a length of an infrastructure being inspected, the method comprising:
launching a probe signal from a first optical source with a narrow linewidth into a sensing fiber coupled to the infrastructure;
routing a backscattered probe signal generated by reflection of the probe signal from the infrastructure with a Brillouin frequency shift to a balanced heterodyne receiver configured for narrow band detection at radio frequency (RF) bandwidth;
producing a local oscillation signal from a second optical source with a narrow linewidth used as a local oscillator, wherein the first optical source and the second optical source are coherently locked with a predefined frequency offset with respect to each other, the predefined frequency offset being in the order of the Brillouin frequency shift, and wherein the first optical source and the second optical source are included in an optical phase lock loop (OPLL) system;
routing the local oscillation signal to the balanced heterodyne receiver;
coherently mixing the backscattered probe signal with the Brillouin frequency shift and the local oscillation signal at the balanced heterodyne receiver; and
producing an output indicative of one or both of a measured temperature and a measured strain.

11. The method of claim 10, wherein the first optical source and the second optical source are semiconductor-based external cavity lasers (ECLs).

12. The method of claim 10, wherein the second optical source coherently locked with the first optical source with a predefined frequency offset allows transfer of heterodyne high frequency RF detection to a narrow frequency band.

13. The method of claim 10, wherein the predefined frequency offset between the first optical source and the second optical source is optimized using the OPLL system, depending on the type of the sensing fiber used, which dictates the Brillouin frequency shift in the sensing fiber.

14. The method of claim 10, wherein low cost low-noise radio frequency (RF) electronics is used for the balanced heterodyne receiver to efficiently detect low level amplitude of the backscattered probe signal with the Brillouin frequency shift, as the required bandwidth of heterodyne detection is reduced as a result of the coherent mixing of the backscattered probe signal with the Brillouin frequency shift and the local oscillation signal, which is already at a predefined frequency offset in the order of the Brillouin frequency shift.

15. The method of claim 10, wherein the balanced heterodyne receiver is coupled to a digitizer, which is coupled to a fast Fourier transform (FFT) processor for reconstructing a Brillouin gain spectrum.

16. The method of claim 15, wherein an electronic local oscillator (ELO) is used to sweep a beat frequency spectrum generated by the balanced heterodyne receiver to reconstruct the Brillouin gain spectrum.

17. The method of claim 10, wherein a beat frequency spectrum produced as a result of the coherent mixing of the backscattered probe signal with the Brillouin frequency shift and the local oscillation signal is in the range of a few hundred MHz.

18. The method of claim 10, where the first optical source is coupled to a semiconductor optical amplifier (SOA) that produces a high extinction-ratio pulse that is amplified by an Erbium-doped fiber amplifier (EDFA) to be used as the probe signal.
